(19) United States
(12) Patent Application Publication
(10) Pub. No.: US 2002/0139963 A1
(43) Pub. Date: Oct. 3, 2002

(54) Composition emitting far infrared rays and method for preparation thereof

(76) Inventor: Hyeon-Jae Kim, Kyonggi-do (KR)

Correspondence Address: WENDEROTH, LIND & PONACK, L.L.P., 2033 K STREET N. W., SUITE 800, WASHINGTON, DC, 20006-1021, US

(21) Appl. No.: 09/801,719

(22) Filed: Mar. 9, 2001

(51) Int. Cl. G03C 1/00

(52) U.S. Cl. 252/582

(57) ABSTRACT

A composition emitting far infrared rays and a method for the preparation thereof The composition comprises a natural mineral powder containing alumina, magnesium oxide, calcium oxide, sodium oxide, potassium oxide, iron oxide, and silica; distilled water; an antimicrobial agent; a urethane silicone resin; and an ionizing catalyst.

### BACKGROUND OF THE INVENTION

(a) Field of the Invention

The present invention relates to a composition emitting far infrared rays, more particularly to a composition emitting far infrared rays which is applied to various fibers such as clothing, etc., and a method for the preparation thereof. The composition exhibits comfortable incense diffusing, antimicrobial, deodorizing and far infrared ray emitting functions, thereby smoothly enhancing metabolism of the human body, and it is widely applied to plant growth promoting agents, health related goods, etc.

(b) Description of the Related Art

Far infrared rays function as oscillating waves of electromagnetic force rays generated by the movement of molecules inside a material object, smoothly enhancing metabolism of the human body. They are therefore applied to various fields of industry, and particularly widely applied to health related goods.

Generally, a far infrared ray emitting substance is manufactured in a powder or liquid phase, and then it is used in manufacturing of certain goods, or it is applied to them by the methods of coating, impregnation, etc.

Particularly in the case of applying materials emitting far infrared rays to textiles such as clothing, etc., the materials are mainly prepared in powder and then liquid phase for application after mixing, adding water thereto, and calcining. However, there are problems in that it is very difficult to ionize the already calcined powdered materials emitting far infrared rays into water in the liquid phase, and it is economically unfavorable.

Therefore, the development of a composition emitting far infrared rays in the liquid phase or ionized state which can be easily applied to fibers is required. For example, a method for the preparation of a liquid composition emitting far infrared rays comprising the steps of dissolving sodium silicate, sodium aluminate, sodium oxide, sodium thiosulfate, germanium dioxide, refined glucose, and very pure white sugar in water respectively at a temperature of 30 to 40° C. and mixing the dissolved solutions to resultantly prepare a first solution; adding a second solution made by ionizing gold to chloroauric acid and a third solution made by ionizing silver nitrate to silver thiosulfate to the first solution; and maintaining the resultant mixture at room temperature for 48 to 72 hours is disclosed in Korean Patent Publication No. 96-15657.

However, the method for the preparation of a liquid composition emitting far infrared rays is to ionize organic compounds, wherein most of the raw materials used are strong alkalines. A liquid composition emitting far infrared rays prepared by the preparation method has a pH of from 11 to 12, and it damages fibers when it is applied to material, it produces yellowing over a certain temperature range during the processing, and it causes a severe change in tactility, thereby limiting the applicable range. Furthermore, the preparation method is economically unfavorable since expensive raw materials including gold are used.

### SUMMARY OF THE INVENTION

The present inventor found that a liquid (ionized) composition emitting far infrared rays prepared inexpensively and simply by a method in which natural minerals of alumina (aluminum oxide) series are crushed into a micro particulate state and then ionized in a liquid phase could be provided, after performing repeated studies to solve the problems.

That is, it is an object of the present invention to provide a composition emitting far infrared rays and a method for the preparation thereof, wherein the composition more greatly benefits the human body since it has high values of emissivity of far infrared rays, as well as comfortable aroma emitting, antimicrobial, and deodorizing functions, and it is not only easily popularized because of it's considerably less expensive price compared to the existing raw materials, but can also be prepared in an acidly neutral state so that it can be widely applied to the various fields of fiber products without any adverse effects during processing.

In order to achieve the above object, the present invention provides a composition emitting far infrared rays comprising 7.0 to 10.0 weight % of natural mineral powder containing 76.0 to 88.0 weight % of alumina, 1.8 to 2.2 weight % of magnesium oxide, 1.8 to 2.0 weight % of calcium oxide, 1.0 to 1.4 weight % of sodium oxide, 0.1 to 0.3 weight % of potassium oxide, 0.1 to 0.3 weight % of iron oxide, and 6.0 to 8.0 weight % of silica; 83.0 to 86.0 weight % of distilled water; 1.0 to 2.0 weight % of an antimicrobial agent; 1.0 to 2.0 weight % of urethane silicone resin; and 2.0 to 3.0 weight % of an ionizing catalyst.

Furthermore, the present invention provides a method for the preparation of a composition emitting far infrared rays, comprising:

A first process of mixing natural mineral powder, distilled water, an antimicrobial agent, urethane silicone resin, and an ionizing catalyst;

a second process of putting the mixture of the first process together with a zirconium based ceramic ball into a mill and stirring, thereby pulverizing the raw materials into particulates;

a third process of selectively adding incense and an antistatic agent to the pulverized particulates of the second process and stirring, thereby ionizing the resultant; and

purifying the ionized resultant of the third process and maintaining at room temperature.

### BRIEF DESCRIPTION OF THE DRAWING

The accompanying drawing, which is incorporated in and forms a part of the specifications, illustrates the preferred embodiment of the present invention, and together with the description serves to explain the principles of the invention. In the drawing:

FIG. 1 is a preparation process flow chart of a composition emitting far infrared rays according to the present invention.

### DETAILED DESCRIPTION OF A PREFERRED EMBODIMENT

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawing and description are to be regarded as illustrative in nature, and not restrictive.

The present invention is described in detail as follows.

A composition emitting far infrared rays of the present invention consists of 7 to 10 weight % of natural mineral powder of alumina series, 83 to 86 weight % of distilled water, 1 to 2 weight % of an antimicrobial agent, 1 to 2 weight % of urethane silicone resin, and 2 to 3 weight % of an ionizing catalyst. 4 to 5 weight %, preferably 2 to 3 weight % of incense, and a small amount of antistatic agent can be further added to the composition emitting far infrared rays.

Natural mineral powder of alumina series used in the present invention contains alumina, magnesium oxide, calcium oxide, sodium oxide, potassium oxide, iron oxide, silica (silicate dioxide), etc., more specifically a mineral powder containing 76 to 88 weight % of alumina, 1.8 to 2.2 weight % of magnesium oxide, 1.8 to 2.0 weight % of calcium oxide, 1.0 to 1.4 weight % of sodium oxide, 0.1 to 0.3 weight % of potassium oxide, 0.1 to 0.3 weight % of iron oxide, and 6 to 8 weight % of silica is used.

The antimicrobial agent and ionizing catalyst are not particularly limited. The incense is an extract which is extracted from natural materials, wherein the aroma of flowers, plants, etc. which is not harmful to the human body is micro-capsulated before using. Furthermore, a method for the preparation of a composition emitting far infrared rays comprises a first process in which natural mineral powder, distilled water, an antimicrobial agent, urethane silicone resin, and an ionizing catalyst are mixed; a second process in which the mixture of the first process together with a zirconium based ceramic ball are put into a mill and stirred, thereby pulverizing the raw materials into particulates; a third process in which incense and an antistatic agent are selectively added to the pulverized particulates of the second process, stirred, and ionized; and a fourth process in which the ionized resultant of the third process is purified and maintained at room temperature.

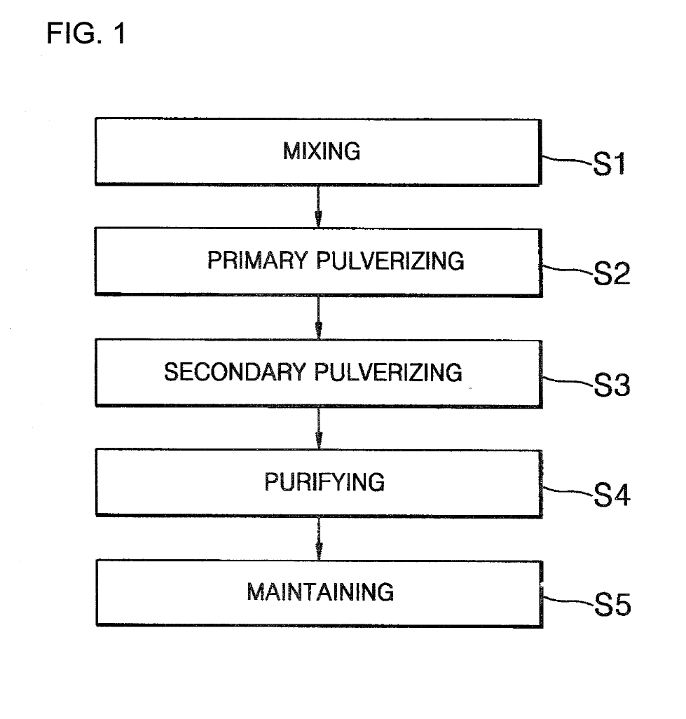

Referring to FIG. 1, the first process is a simple process (S1) in which raw materials are mixed, the second process is a pulverizing process (S2) in which a circulating crusher is operated for about 4 hours at the rate of about 500 rpm so as to pulverize the raw materials, wherein a zirconium based ceramic ball, a crushing ball which has a diameter of about 3 φ together with the mixture are put and stirred so as to promote the pulverization of raw materials. The third process, the second crushing and ionizing process, is a process (S3) in which the resultant of the second process is put into a mixing and crushing machine having a larger capacity, and stirred for about two hours at the rate of about 500 rpm. The fourth process is a process (S5) in which the resultant of the third process is slowly passed through a purifying system (S4: purifying process), while maintaining the purified solution at room temperature for about one day.

In the above preparation process, incense and an antistatic agent to be used as raw materials can be mixed together with other raw materials in the first process, and can be added to the mixture. Characteristics of an ionized composition emitting far infrared rays according to the present invention and a liquid composition emitting far infrared rays prepared by the method for the preparation thereof which is disclosed in Korean Patent Publication No. 96-15657 are measured at a temperature of 35° C., and are compared in the following Table 1.

TABLE 1
Characteristics comparison

| | Raw materials of | Raw materials of the |
|---|---|---|
| Measuring items | the prior art | present invention |
| Values of emissivity | 77% | 82% |
| Values of emitting intensities | 0.8 W | 0.83 W |
| Main constituents | Small amount of | Al₂O₃ series |
| | Si, K, Na, etc. | |
| Preparation method | Ionization of | Ionization of |
| | organic compounds | natural minerals |
| Hydrogen ion concentration | 11 to 12 | 3 to 11 |
| (pH) | | |
| Antimicrobial properties | 53.4% | 67.6% |
| Comfortable fragrance | none | existing |
| Yellowing | | not occurred |
| Tactility change | occurred (changed | no change |
| | from 130° C.) | |
| Suspended particles | hardened after processing | none |
| Application range | existing | all fields of fiber industry |
| Prices | limited | 6,000 won/kg |
| | 165,000 won/kg | |

Referring to the Table 1, a composition emitting far infrared rays according to the present invention has higher values of emissivity and emitting intensity of far infrared rays compared to the prior art, and can be prepared acidly neutral since a composition of the present invention has a pH of from 3 to 11 while a composition of the prior art has a pH of from 11 to 12. Therefore, since an acidly neutral composition emitting far infrared rays has no adverse effects when it is used in processing fabric, it can be widely applied to all fields of the fiber industry. Furthermore, a composition of the present invention not only provides multi-functionality such as comfortable fragrance emitting, antimicrobial and deodorizing functions, but it is also economical since its price is only about 1/30th of a composition of the prior art.

Furthermore, yellowing occurred at a temperature of 130° C. when raw materials of the prior art were applied to fiber, while yellowing was not discovered when a composition of the present invention was applied to fiber. The reason why yellowing did not occur even though urethane silicone resin was used in a composition of the present invention is thought to be that not only was a used amount of urethane based resin minimal, but also other constituents were applied to the urethane based resin during the ionizing process, thereby changing characteristics thereof.

As described in the above, since a composition emitting far infrared rays according to the present invention has antimicrobial, deodorizing, and antistatic functions, it not only generates a unique natural fragrance when applied to fiber, thereby providing a comfortable aroma, refreshment, etc., but it also removes various scents surrounding the body of a person wearing a fiber product so that a more pleasant life can be lived. Furthermore, it is not only easily popularized because of considerably cheaper price compared to the existing raw materials, but it can also be prepared acidly neutral so that it can be widely applied to the various fields of fiber without any adverse effects.

In this disclosure, there is shown and described only the preferred embodiment of the invention, but, as aforementioned, it is to be understood that the invention is capable of use in various other combinations and environments and is capable of changes or modification within the scope of the inventive concepts as expressed herein.

What is claimed is:

1. A composition emitting far infrared rays comprising 7.0 to 10.0 weight % of natural mineral powder containing 76.0 to 88.0 weight % of alumina, 1.8 to 2.2 weight % of magnesium oxide, 1.8 to 2.0 weight % of calcium oxide, 1.0 to 1.4 weight % of sodium oxide, 0.1 to 0.3 weight % of potassium oxide, 0.1 to 0.3 weight % of iron oxide, and 6.0 to 8.0 weight % of silica; 83.0 to 86.0 weight % of distilled water; 1.0 to 2.0 weight % of an antimicrobial agent; 1.0 to 2.0 weight % of urethane silicone resin; and 2.0 to 3.0 weight % of an ionizing catalyst.

2. The composition emitting far infrared rays in accordance with claim 1 to which 4.0 to 5.0 weight % of incense is further added.

3. The composition emitting far infrared rays in accordance with claim 1 to which an antistatic agent is further added.

4. A method for the preparation of a composition emitting far infrared rays, comprising:
a first process of mixing natural mineral powder, distilled water,
an antimicrobial agent, urethane silicone resin, and an ionizing catalyst;
a second process of putting the mixture of the first process together with a zirconium based ceramic ball into a mill and stirring, thereby pulverizing the raw materials into particulates;
a third process of selectively adding incense and an antistatic agent to the pulverized particulates of the second process and stirring, thereby ionizing the resultant; and
purifying the ionized resultant of the third process and maintaining at room temperature.
